(19) United States
(12) Patent Application Publication
(10) Pub. No.: US 2014/0317717 A1
(43) Pub. Date: Oct. 23, 2014

(54) FIREWALL SETTINGS CONTROLLING METHOD

(71) Applicant: Hon Hai Precision Industry Co., Ltd., New Taipei (TW)

(72) Inventors: CHUNG-I LEE, New Taipei (TW); TSUNG-HSIN YEN, New Taipei (TW); CHIEN-CHIH LIN, New Taipei (TW)

(73) Assignee: HON HAI PRECISION INDUSTRY CO., LTD., New Taipei (TW)

(21) Appl. No.: 13/965,234

(22) Filed: Aug. 13, 2013

(30) Foreign Application Priority Data
Apr. 23, 2013 (CN) 2013101432120

(51) Int. Cl. H04L 29/06

(52) U.S. Cl. CPC H04L 63/02
USPC 726/11

(57) ABSTRACT

A management server includes a control module. The management server electronically connects with one or more firewall, and each firewall connects one or more VMs which are installed in the same or different hosts. The control module sends a firewall setting command to a firewall agent module of each firewall, and controls the firewall agent module to set parameters of the firewall according to the firewall setting command. Furthermore, the control module sends a VM control command to a host agent module of each host, and controls the host agent module to perform one or more operations on one or more VMs in the host.

### BACKGROUND

1. Technical Field

Embodiments of the present disclosure relate to virtualization technology, and more particularly to a method for controlling settings of firewalls of virtual machines.

2. Description of Related Art

Virtual machines (VM) are software implementations that create one or more VMs in a host. In a process of establishing a virtualization environment, a large number of hosts may be involved and a large number of VMs may be created. To protect security of the VMs, multiple firewalls are set between the VMs and an external network (e.g., the Internet). Presently, settings of the multiple firewalls are done manually by a network manager. The network manager uses a management server to connect to each firewall and perform the setting operations for the firewalls one by one, which is repetitive and time-consuming. Therefore, this is room for improvement in the art.

### BRIEF DESCRIPTION OF THE DRAWINGS

FIG. 1 is a block diagram of one embodiment of a firewall settings controlling system.

FIG. 2 is a flowchart of one embodiment of a firewall settings controlling method.

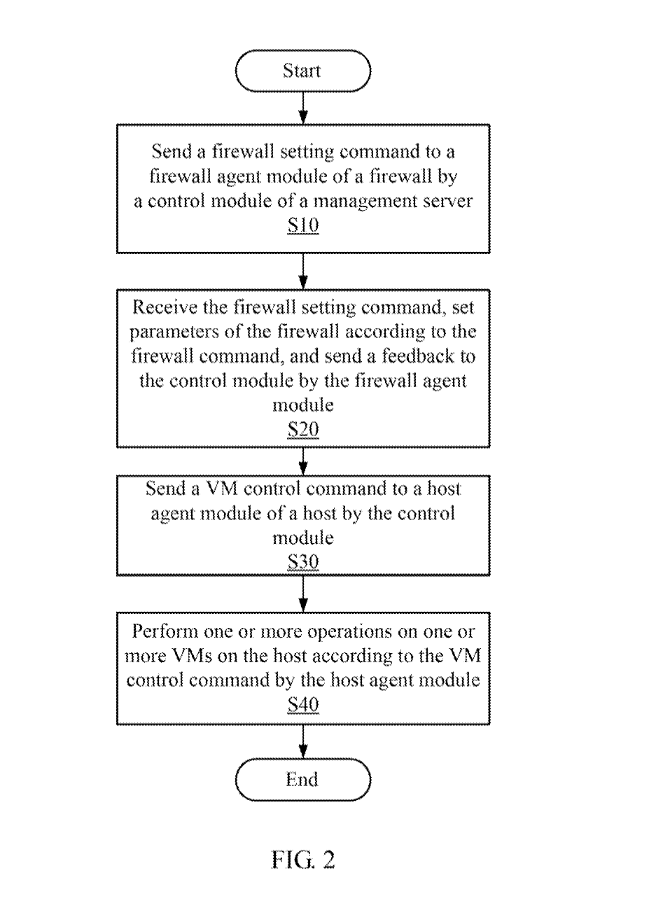

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

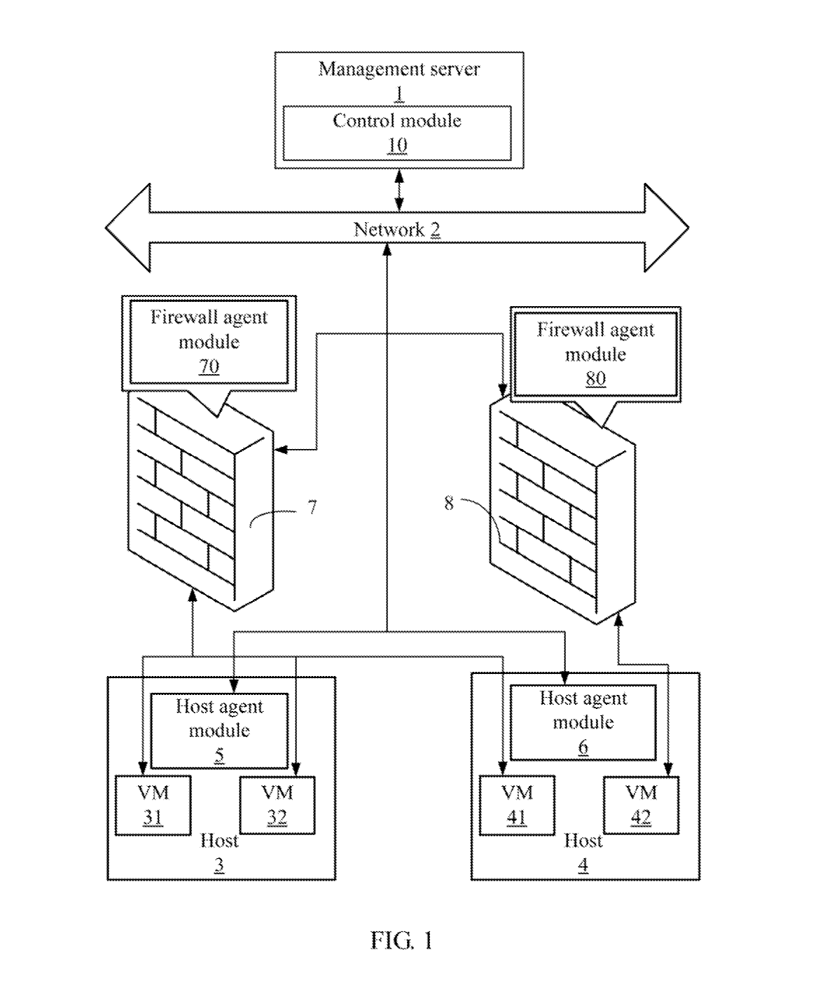

FIG. 1 is a block diagram of one embodiment of a firewall settings controlling system (hereinafter the “system”). The system includes a control module 10 installed in a management server 1. The management server 1 is electronically connected to one or more firewalls, such as a firewall 7 and a firewall 8, as shown in FIG. 1, via a network 2. In one embodiment, the system further includes a firewall agent module installed in each firewall, such as a firewall agent module 70 installed in the firewall 7 and a firewall agent module 80 installed in the firewall 8. Each firewall connects one or more VMs which are installed in the same or in a different host. For example, the firewall 7 connects to VMs 31 and 32 installed in a host 3, and the firewall 8 connects to VMs 41 and 42 installed in a host 4. The host 3 includes a host agent module 5, and the host 4 includes a host agent module 6.

In one embodiment, the management server 1 may be a machine independent from any host, or may be a VM installed in any host. The aforementioned modules, such as the control module 10, and the firewall agent modules 70 and 80, include computerized code in the form of one or more programs, which may be stored in the same storage device or different storage devices. For one example, the one or more programs of the control module 10 and the firewall agent modules 70 and 80 may be stored in a network storage device (not shown in FIG. 1), which is electronically connected to the network 2. For another example, the one or more programs of the control module 10 and the firewall agent modules 70 and 80 may be respectively stored in a storage device of a computing device in which the module is installed. For example, the one or more programs of the control module 10 may be stored in a storage device of the management server 1, and the one or more programs of the firewall agent module 70 may be stored in a storage device of the firewall 7 on condition that the firewall 7 is a hardware-based network system. A processor (not shown) of the management server 1 executes instructions of the one or more programs of the control module 10, and a processor of a computing device (not shown) in which a firewall executes instructions of the one or more programs of the firewall agent module of the firewall, to provide functions of the control module 10 and the firewall agent modules as described below.

The control module 10 sends a firewall setting command to each firewall agent module (e.g., the firewall agent modules 70 and 80) of each firewall (e.g., the firewalls 7 and 8). The firewall agent module (e.g., the firewall agent module 70) receives the firewall setting command, sets parameters of the firewall (e.g., the firewall 7) according to the firewall setting command, and feeds back a reply to the control module 10. The firewall setting command may include adding, amending, or deleting firewall rules (e.g., packet filtering rules) of the firewall.

The control module 10 may further send a VM control command to each host agent module (e.g., the host agent modules 5, 6) of each host (e.g., the hosts 3, 4). The host agent module (e.g., the host agent module 5) receives the VM control command, and performs one or more operations on the one or more VMs in the host (e.g., the host 3). The operations may include adding a new VM, or deleting or shutting down a designated VM, for example.

FIG. 3 is a flowchart of one embodiment of a VM security protection method. Depending on the embodiment, additional steps may be added, others removed, and the ordering of the steps may be changed.

In step S10, the control module 10 sends a firewall setting command to the firewall agent module of each firewall. As mentioned above, the firewall setting command may include adding, amending, or deleting firewall rules (e.g., packet filtering rules) of the firewall. In one embodiment, the control module 10 may send the firewall setting command to each of the firewall agents one by one, or simultaneously send the firewall setting command to all the firewall agents. Different firewalls may have same firewall setting command or different firewall setting commands. For example, the control module 10 may send a first firewall setting command to the firewall agent modules 70 and 80, or send the first firewall setting command to the firewall agent module 70 and send a second firewall setting command to the firewall agent module 80.

In step S20, the firewall agent module receives the firewall setting command, sets parameters of the firewall according to the firewall setting command, and feeds back a reply to the control module 10. For example, if the first firewall setting command received by the firewall agent module 70 refers to adding a packet filtering rule, the firewall agent module 70 adds the packet filtering rule into the settings of the firewall 7, and sends present settings of the firewall 7 to the control module 10.

In step S30, the control module 10 sends a VM control command to a host agent module of a host, such as the host agent module 5 of the host 3. The VM control command may include an ID of a VM, and one or more operations to be performed on the VM.

In step S40, the host agent module receives the VM control command, and performs the one or more operations on a designated VM according to the VM control command. For example, the host agent module 5 searches for the VM among all the VMs in the host 3 according to the ID of the VM contained in the VM control command, and performs the one or more operations on the searched VM.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A method being executed by a processor of a management server, the management server being electronically connected to one or more firewalls via a network, and each firewall being connected to one or more virtual machines (VMs) installed in one or more hosts, the method comprising:
providing a control module in the management server; and
sending a firewall setting command to a firewall agent module of each firewall, and controlling the firewall agent module to set parameters of the firewall according to the firewall setting command by the control module.

2. The method as claimed in claim 1, further comprising:
receiving a feedback sent from the firewall agent module by the control module.

3. The method as claimed in claim 1, further comprising:
sending a VM control command to a host agent module of each host, and controlling the host agent module to perform one or more operations on one or more VMs in the host by the control module.

4. A method being executed by a processor of a computing device in which a firewall is configured, the firewall being connected to a management server and one or more virtual machines (VMs) installed in one or more hosts, the method comprising:
providing a firewall agent module in the firewall;
receiving a firewall setting command sent from a control module of the management server, and setting parameters of the firewall according to the firewall setting command by the firewall agent module.

5. The method as claimed in claim 4, further comprising:
sending a feedback to the control module by the firewall setting command after the setting operation.

6. A non-transitory computer-readable medium having stored thereon instructions that, when executed by a processor of a management server, cause the processor to perform operations of:
providing a virtual machine (VM) management module in the management server; and
sending a firewall setting command to a firewall agent module of a firewall connected to the management server, and controlling the firewall agent module to set parameters of the firewall according to the firewall setting command by the control module.

7. The medium as claimed in claim 6, wherein the operations further comprise:
receiving a feedback sent from the firewall agent module by the control module.

8. The medium as claimed in claim 6, wherein the operations further comprise:
sending a VM control command to a host agent module of a host by the control module, wherein the host is connected to the management server via a network and the firewall is connected to one or more VMs of the host; and
controlling the host agent module to perform one or more operations on one or more VMs in the host by the control module.
